(19) United States
(12) Patent Application Publication
(10) Pub. No.: US 2025/0371796 A1
(43) Pub. Date: Dec. 4, 2025

(54) IMAGE PROCESSING SYSTEM, IMAGE PROCESSING METHOD, AND STORAGE MEDIUM

(71) Applicant: CANON KABUSHIKI KAISHA, Tokyo (JP)

(72) Inventor: YANGTAI SHEN, Tokyo (JP)

(21) Appl. No.: 19/209,391

(22) Filed: May 15, 2025

(30) Foreign Application Priority Data
May 30, 2024 (JP) 2024-088440

(51) Int. Cl. G06T 15/20; G06T 7/55; G06T 7/73; G06T 7/90

(52) U.S. Cl. CPC G06T 15/205; G06T 7/55; G06T 7/74; G06T 7/90; G06T 2200/08; G06T 2207/10024; G06T 2207/30244; G06T 2210/62

(57) ABSTRACT

An image processing apparatus includes an obtaining unit configured to obtain viewpoint information indicating a position of a virtual viewpoint and a line-of-sight direction from the virtual viewpoint, a first generation unit configured to generate a first virtual viewpoint image including a transparent or translucent first portion of a subject using the viewpoint information and a first captured image including the first portion and a pixel not corresponding to an opaque second portion of the subject to be captured through the first portion among pixels corresponding to the first portion, and generate a second virtual viewpoint image including the second portion using the viewpoint information and a second captured image including the second portion, and a second generation unit configured to generate a third virtual viewpoint image including the first portion and the second portion based on the first virtual viewpoint image and the second virtual viewpoint image.

### BACKGROUND

### Field

The present disclosure relates to an image processing system, an image processing method, and a storage medium.

### Description of the Related Art

A technique for generating a virtual viewpoint image to reproduce a view from a virtual point using a plurality of captured images obtained through image capturing by a plurality of image capturing apparatuses located at different positions has been attracting much attention. It is expected that this technique can be applied to a wide variety of fields, including live sports broadcasting on television or the like and filming, and it is assumed that images of subjects having various features are captured. For example, it is assumed that an image of a performer wearing a costume made of thin cloth can be captured, and an image of a performer can be captured together with an image of a tool made of glass, acrylic resin, or the like and a background set. In other words, it is assumed that an image of a subject having portions different in transmittance, or an image of a plurality of subjects having different transmittances can be captured.

In a related art, a texture of a subject area in a virtual viewpoint image is determined using a texture of a subject area in a plurality of captured images to generate the virtual viewpoint image. Accordingly, in the case of capturing an image of a subject having a high transmittance, the captured image includes a background behind the subject, so that the texture of the image including the background as viewed from an image capturing apparatus is also generated in the area of the subject in the virtual viewpoint image to be generated. In this case, if a virtual viewpoint for generating a virtual viewpoint image is set at a position different from the position of the image capturing apparatus, it is assumed that the background visible through the subject having a high transmittance from the image capturing apparatus is different from the background visible through the subject having a high transmittance from the virtual viewpoint. However, the texture of the image including the background in the real space viewed from the image capturing apparatus is generated in the area of the subject in the virtual viewpoint image to be generated, so that a virtual viewpoint image with a sense of incongruity is generated.

Japanese Patent Application Laid-Open No. H06-225329 discusses a technique for removing background color information from an area of a subject in a captured image obtained by capturing an image of a subject having a high transmittance, thereby generating the captured image in which the background image is not included in the area of the subject having a high transmittance. The application of this technique makes it possible to generate a virtual viewpoint image using the captured image in which the background in the real space is not included in the area of the subject having a high transmittance, so that a virtual viewpoint image with no sense of incongruity can be generated.

In a case where a captured image including an image of a subject having a high transmittance includes an image of another subject behind the subject, color information about the other subject cannot be removed from the area of the subject, so that a virtual viewpoint image with a sense of incongruity is generated.

### SUMMARY

According to the present disclosure, it is possible to generate a virtual viewpoint image that includes an image of a subject having a high transmittance and is represented by appropriate colors.

According to an aspect of the present disclosure, an image processing system includes one or more memories configured to store instructions, and one or more processors configured to, upon executing the instructions, obtain viewpoint information indicating a position of a virtual viewpoint and a line-of-sight direction from the virtual viewpoint, generate a first virtual viewpoint image including a transparent or translucent first portion of a subject using the viewpoint information and a first captured image including the first portion and a pixel not corresponding to an opaque second portion of the subject to be captured through the first portion among a plurality of pixels corresponding to the first portion, and generate a second virtual viewpoint image including the second portion using the viewpoint information and a second captured image including the second portion, and generate a third virtual viewpoint image including the first portion and the second portion based on the first virtual viewpoint image and the second virtual viewpoint image.

Further features of the present disclosure will become apparent from the following description of exemplary embodiments with reference to the attached drawings.

### BRIEF DESCRIPTION OF THE DRAWINGS

FIG. 1 is a block diagram illustrating an overall configuration of an image processing system according to one or more aspects of the present disclosure.

FIG. 2 is a flowchart illustrating processing for generating a virtual viewpoint image according to one or more aspects of the present disclosure.

FIGS. 3A to 3C each illustrate an outline of an assumed scene according to one or more aspects of the present disclosure.

FIG. 4 is a flowchart illustrating texture selection processing to be performed by a texture selection unit according to one or more aspects of the present disclosure.

FIGS. 5A to 5D are image diagrams each illustrating a determination result from the texture selection unit according to one or more aspects of the present disclosure.

FIGS. 6A to 6C are image diagrams each illustrating a determination result from the texture selection unit according to one or more aspects of the present disclosure.

FIG. 7 is a flowchart illustrating virtual viewpoint image generation processing to be performed by a virtual viewpoint image generation unit according to one or more aspects of the present disclosure.

FIGS. 8A to 8C are image diagrams each illustrating a rendering result from the virtual viewpoint image generation unit according to one or more aspects of the present disclosure.

FIG. 9 is a block diagram illustrating a hardware configuration of an image processing apparatus according to one or more aspects of the present disclosure.

FIG. 10 is a block diagram illustrating an overall configuration of an image processing system according to one or more aspects of the present disclosure.

FIG. 11 is a flowchart illustrating captured image correction processing to be performed by a captured image correction unit according to one or more aspects of the present disclosure.

### DESCRIPTION OF THE EMBODIMENTS

An image processing system according to an exemplary embodiment of the present disclosure includes an obtaining unit that obtains a position of a virtual viewpoint and viewpoint information indicating a line-of-sight direction from the virtual viewpoint. The image processing system obtains a first captured image including a transparent or translucent first portion of a subject and the pixel(s) not corresponding to an opaque second portion of the subject to be captured through the first portion among a plurality of pixels corresponding to the first portion. The image processing system includes a first generation unit that generates a first virtual viewpoint image including the first portion using the first captured image and the viewpoint information. The first generation unit generates a second virtual viewpoint image including the second portion using the viewpoint information and a second captured image including the second portion. The image processing system includes a second generation unit that generates a third virtual viewpoint image including the first portion and the second portion based on the first virtual viewpoint image and the second virtual viewpoint image. The first generation unit and the second generation unit may be the same generation unit. In this case, the first virtual viewpoint image is a virtual viewpoint image for which coloring processing has been performed only on the transparent or translucent first portion of the subject, and the second virtual viewpoint image is a virtual viewpoint image for which coloring processing has been performed only on the opaque second portion of the subject. Accordingly, the use of the first virtual viewpoint image and the second virtual viewpoint image makes it possible to generate the third virtual viewpoint image including the first portion and the second portion. Specifically, the third virtual viewpoint image may be generated by combining the first virtual viewpoint image with the second virtual viewpoint image. The first virtual viewpoint image may include both the first portion and the second portion, instead of including only the first portion. The subject refers to an object to be captured by a plurality of image capturing apparatuses in the real space. A plurality of objects may be collectively referred to as a subject. A single object may be referred to as a subject. The plurality of objects described above is collectively referred to as the subject.

With this configuration, color information about an area of a subject with a high transmittance in the virtual viewpoint image can be determined using color information about an area in which no other subjects are present behind the subject with a high transmittance in the captured image. Accordingly, even if the position of the virtual viewpoint is set at a position different from the position of the image capturing apparatus, a virtual viewpoint image can be generated without any sense of incongruity, where appropriate color information is set to a subject area with a high transmittance.

In the image processing system described above, the pixel not corresponding to the second portion to be captured through the first portion in the first captured image corresponds to a specific pixel of the first portion in the first virtual viewpoint image. The first generation unit determines color information about the specific pixel in the first virtual viewpoint image using color information about the pixel not corresponding to the second portion to be captured through the first portion.

The pixel not corresponding to the second portion to be captured through the first portion in the first captured image and the specific pixel of the first portion in the first virtual viewpoint image correspond to a specific component of a three-dimensional shape of the subject. The three-dimensional shape of the subject is formed of a point group. If each component is a point, a certain point in the point group corresponds to the pixel not corresponding to the second portion to be captured through the first portion in the first captured image and the specific pixel of the first portion in the first virtual viewpoint image.

With this configuration, the first generation unit can determine color information about the specific pixel in the first virtual viewpoint image using color information about the pixel not corresponding to the second portion to be captured through the first portion.

The second captured image may be a captured image including the second portion to be captured through the first portion. In other words, the first captured image used to generate the first virtual viewpoint image and the second captured image used to generate the second virtual viewpoint image may be the same captured image.

The first generation unit determines color information about the second portion in the second virtual viewpoint image using color information excluding color information corresponding to the first portion from color information about a pixel corresponding to the second portion to be captured through the first portion in the first captured image. For example, if the second portion is visible through the translucent first portion in the first captured image, the pixel corresponding to the second portion in the first captured image includes color information about the first portion and color information about the second portion. Accordingly, color information about the second portion can be determined based on the first captured image by removing the color information about the first portion.

The obtaining unit obtains a plurality of captured images including the subject. Further, the obtaining unit obtains a plurality of pieces of transmittance information each corresponding to a corresponding captured image of the plurality of captured images using a trained model configured to output the plurality of pieces of transmittance information indicating a transmittance of an area corresponding to the subject in the plurality of captured images using the plurality of captured images as an input. Instead of using a trained model to obtain transmittance information, transmittance information may be obtained by an existing method. For example, an image recognition technique may be used to identify the material of each subject in a captured image, and the transmittance may be set for each material. The image processing system includes an identification unit that identifies the first captured image and the second captured image among the plurality of captured images based on the plurality of pieces of transmittance information.

With this configuration, the first portion and the second portion in the captured image can be identified, and thus the first captured image and the second captured image can be identified.

The first generation unit generates shape information indicating a three-dimensional shape of the subject based on the plurality of captured images, positional information about a plurality of image capturing apparatuses that has captured the plurality of captured images, and the plurality of pieces of transmittance information. In this case, the shape information includes a transparent or translucent first component and an opaque second component. The first component is a component that constitutes a transparent or translucent portion of a three-dimensional shape representing a subject in a virtual space and corresponds to the transparent or translucent first portion of the subject in the real space. The second component is a component that constitutes an opaque portion of a three-dimensional shape representing a subject in the virtual space and corresponds to the opaque second portion of the subject in the real space. Accordingly, a plurality of first components in the virtual space corresponds to the first portion in the real space, and a plurality of second components in the virtual space corresponds to the second portion in the real space.

With this configuration, a three-dimensional (3D) model of the subject including the first component and the second component in the virtual space can be generated from the subject including the first portion and the second portion in the real space.

The identification unit identifies, as the first captured image, a captured image in which the first portion is included in an image capturing range of an image capturing apparatus and the second component is not present on a straight line passing through the first component from a position in the virtual space corresponding to a position in the real space of the image capturing apparatus, among the plurality of captured images. The identification unit identifies, as the captured image including the second portion, the captured image including the second portion in the image capturing range of the image capturing apparatus.

The identification unit identifies, as a transparent or translucent area, an area with a transmittance in the area corresponding to the subject being more than or equal to a threshold in each of the plurality of captured images, and identifies, as an opaque area, an area with a transmittance in the area corresponding to the subject being less than the threshold. In the case of calculating the transmittance in each pixel of a captured image using an existing method, the captured image can be divided into a transparent or translucent area and an opaque area. How to identify each area based on the threshold is not limited to the above-described method. For example, an area with a transmittance being more than the threshold may be identified as the transparent or translucent area, and an area with a transmittance being less than or equal to the threshold may be identified as the opaque area.

The first generation unit generates the first component using the transparent or translucent area in the plurality of captured images, and generates the second component using the opaque area in the plurality of captured images. The shape information indicating the three-dimensional shape of the subject is generated using the first component and the second component.

The second generation unit generates the third virtual viewpoint image by removing a background color from an area corresponding to the first portion in the first virtual viewpoint image and combining the first virtual viewpoint image with the second virtual viewpoint image. The term “background color” used herein refers to color information about a background visible through the subject with a high transmittance in the first captured image.

With this configuration, the background color in the real space included in the first captured image can be removed from the first virtual viewpoint image. As a result, the third virtual viewpoint image does not include color information about the background in the real space. Therefore, if another background model is set in the virtual space, a virtual viewpoint image with no sense of incongruity is generated.

Each unit included in the image processing system described above may be controlled by one computer, or may be controlled by a plurality of computers. Each unit included in the image processing system described above may be recorded on one computer program, or may be recorded on a plurality of computer programs.

Exemplary embodiments of the present disclosure will be described below with reference to the accompanying drawings. The following exemplary embodiments are not intended to limit the present disclosure, and not all combinations of features described in the exemplary embodiments are necessarily deemed to be essential. The same components are denoted by the same reference numerals, and redundant description is omitted.

The term “virtual viewpoint image” refers to an image to be generated by a user freely operating a position and orientation of a virtual camera. The virtual viewpoint image is also referred to as a free viewpoint image, a custom viewpoint image, or the like. Unless otherwise noted, it is assumed that the term “image” includes the concepts of a moving image and a still image.

Viewpoint information used to generate the virtual viewpoint image is information indicating a position and an orientation of a virtual viewpoint (line-of-sight direction). Specifically, viewpoint information is a parameter set including parameters representing a three-dimensional position of a virtual viewpoint, and parameters representing an orientation of a virtual viewpoint in pan, tilt, and roll directions. The details of the viewpoint information are not limited to the above-described parameters. For example, the parameter set for the viewpoint information may include a parameter representing a size (angle of view) of a field of view of a virtual viewpoint. The viewpoint information may include a plurality of parameter sets. For example, the viewpoint information may include a plurality of parameter sets each corresponding to a corresponding frame of a plurality of frames constituting a moving image of a virtual viewpoint image, and may indicate a position and an orientation of a virtual viewpoint at each of successive points of time.

An image processing system to be described below includes a plurality of image capturing apparatuses configured to capture images of an image capturing area from a plurality of directions. Examples of the image capturing area include a stadium where sporting events, such as soccer or karate matches, are held, and a stage where a concert or a play is performed. The plurality of image capturing apparatuses is each placed at different positions to surround the image capturing area, and performs image capturing in synchronization. The plurality of image capturing apparatuses need not necessarily be placed on the entire circumference of the image capturing area, but instead may be placed on a part of the area surrounding the image capturing area, depending on the limitation of an installation place or the like. The number of the image capturing apparatuses to be placed is not limited to the number illustrated in the drawings. For example, if a soccer stadium is set as the image capturing area, about 30 image capturing apparatuses may be placed around the stadium. Image capturing apparatuses having different functions, including a telescopic camera and a wide-angle camera, may be placed.

Assume that each of the plurality of image capturing apparatuses according to the exemplary embodiments is a camera that includes an independent casing and is configured to capture an image with a single viewpoint. However, the configuration of each of the image capturing apparatuses is not limited to this example. Two or more image capturing apparatuses may be configured within a casing. For example, a single camera that includes a plurality of lens groups and a plurality of sensors and is configured to capture images from a plurality of viewpoints may be placed as the plurality of image capturing apparatuses.

The virtual viewpoint image is generated by, for example, the following method. First, the plurality of image capturing apparatuses each captures images from different directions, thereby obtaining a plurality of images (plurality of captured images). Secondary, a foreground image obtained by extracting a foreground area corresponding to a predetermined object, such as a person or a ball, and a background image obtained by extracting a background area other than the foreground area are obtained from the plurality of captured images. A foreground model representing a three-dimensional shape of the predetermined object and texture data for coloring the foreground model are generated based on the foreground image, and texture data for coloring a background model representing a three-dimensional shape of a background such as a stadium is generated based on the background image. The texture data is mapped onto the foreground model and the background model and rendering is performed according to the virtual viewpoint indicated by the viewpoint information, thereby generating a virtual viewpoint image. The method for generating the virtual viewpoint image is not limited to this method. Various methods, including a method of generating a virtual viewpoint image by performing projective transformation on the captured image without using a three-dimensional model, can be used.

The foreground image is an image obtained by extracting an object area (foreground area) from the captured image obtained through image capturing by an image capturing apparatus. The object extracted as the foreground area is a dynamic object (moving object) with a motion (absolute position or shape of the object can vary) when image capturing is performed from the same direction in time series. Examples of the object include a person such as a player or a referee in the field for a sports event, a ball in a ball game, and a singer, a player, a performer, a host, or the like in a concert or an entertainment.

The background image is an image of an area (background area) different from the object that corresponds to at least the foreground. Specifically, the background image is an image obtained by removing the object corresponding to the foreground from the captured image. The background indicates an image capturing target that remains stationary or nearly stationary when images are captured from the same direction in time series. Examples of the image capturing target include a stage for concerts or the like, a stadium for performing sports events or the like, a structure such as a goal post used in ball games, and a field. The background is an area different from the object corresponding to at least the foreground, and the image capturing target may include another object or the like in addition to the object and the background.

The virtual camera is a virtual camera different from the plurality of image capturing apparatuses actually placed around the image capturing area, and is a concept used to conveniently d describe a virtual viewpoint involved in generating a virtual viewpoint image. In other words, the virtual viewpoint image can be regarded as an image captured from a virtual viewpoint set in the virtual space associated with the image capturing area. The position and orientation of the virtual viewpoint in the image capturing can be represented as the position and orientation of the virtual camera. In other words, assuming that a camera is present at a virtual viewpoint position set in the space, it can be said that the virtual viewpoint image is a simulated image of the captured image obtained by the camera.

In a first exemplary embodiment, an area where another subject is present behind a translucent subject is detected for the translucent subject, and the area detected as the area with the other subject is selected so as to prevent the area from being used for rendering.

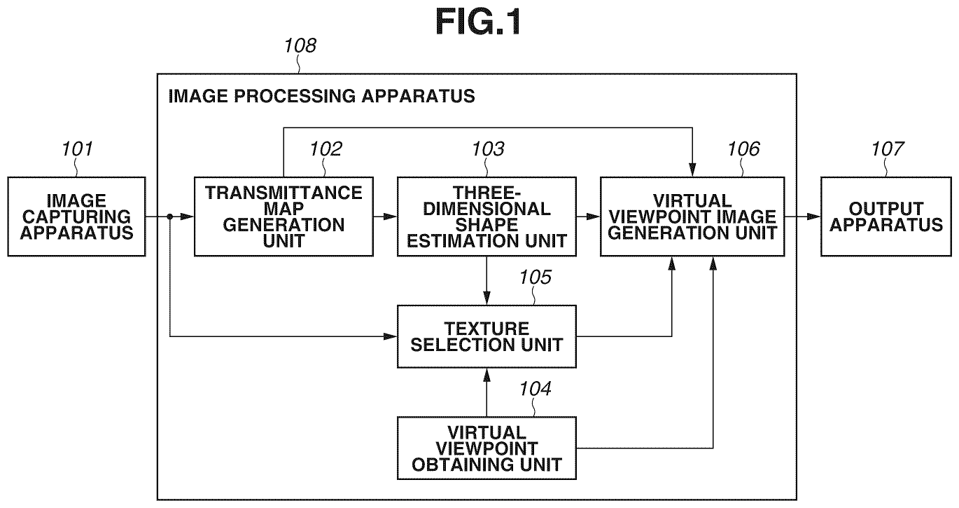

FIG. 1 is a block diagram illustrating a configuration example of an image processing system according to the first exemplary embodiment. The image processing system includes an image capturing apparatus 101, an image processing apparatus 108, and an output apparatus 107. The image processing apparatus 108 includes a transmittance map generation unit 102, a three-dimensional shape estimation unit 103, a virtual viewpoint obtaining unit 104, a texture selection unit 105, and a virtual viewpoint image generation unit 106.

The image processing system generates a virtual viewpoint image representing a scene from a designated virtual viewpoint based on a plurality of images obtained through image capturing by a plurality of image capturing apparatuses and the designated virtual viewpoint. The virtual viewpoint image according to the first exemplary embodiment is also referred to as a free viewpoint video image. The virtual viewpoint image is not limited to an image corresponding to a viewpoint freely (randomly) designated by a user. For example, the virtual viewpoint image also includes an image corresponding to a viewpoint selected by the user from among a plurality of candidates. In the first exemplary embodiment, a case where a virtual viewpoint is designated with a user operation will be mainly described. Alternatively, the virtual viewpoint may be automatically designated based on an image analysis result or the like. In the first exemplary embodiment, a case where a moving image is used as the virtual viewpoint image is mainly described. Alternatively, a still image may be used as the virtual viewpoint image. Each constituent unit of the image processing system may be configured using a single electronic device, or may be configured using a plurality of electronic devices.

The image capturing apparatus 101 indicates a plurality of physical cameras. The plurality of physical cameras is placed at different positions, and captures images of a subject from a plurality of viewpoints in synchronization. A plurality of captured images, viewpoint information (external parameters, internal parameters, image size, and focal distance) about a plurality of image capturing apparatuses 101, and the like are transmitted to the transmittance map generation unit 102 and the texture selection unit 105. The number of cameras to be placed is not particularly limited. External parameters for each image capturing apparatus 101 include positional information indicating the position of the image capturing apparatus 101 and orientation information indicating the orientation of the image capturing apparatus 101. The use of the viewpoint information makes it possible to identify an image capturing range in each image capturing apparatus 101.

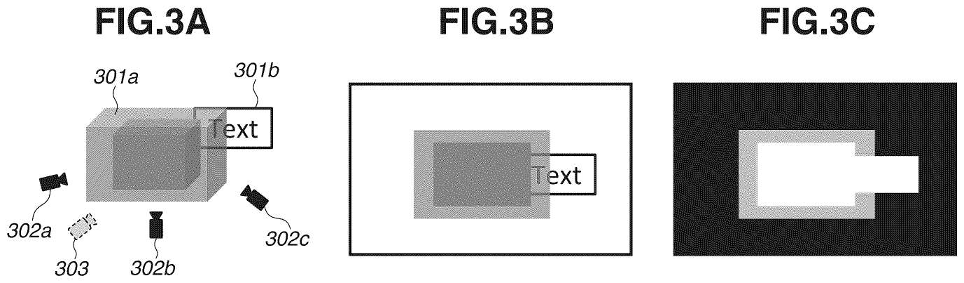

The transmittance map generation unit 102 generates a transmittance map for each image captured by the image capturing apparatus 101, with transmission information indicating a transmittance for each pixel of a subject on the corresponding captured image. Each transmittance map is a multi-value mask having a higher value as the transmittance of the subject in the corresponding captured image increases. For example, FIG. 3B illustrates a captured image that is obtained by a camera 302b capturing an image of a scene illustrated in FIG. 3A. FIG. 3C illustrates a transmittance map for this captured image generated by the transmittance map generation unit 102. As a method for generating the transmittance map, for example, as discussed in Japanese Patent Application Laid-Open No. H06-225329, the transmittance of the foreground is calculated using a preliminarily obtained background image or background color. The transmittance map may be inferred using machine learning techniques. Opacity may be obtained in place of the transmittance.

The three-dimensional shape estimation unit 103 estimates a three-dimensional shape including transmission information using the transmittance map generated by the transmittance map generation unit 102. The three-dimensional shape estimation method is not particularly limited. For example, a visual hull intersection method or stereo method may be used. To include transmission information in the three-dimensional shape, for example, the following processing may be used. Binarization of the transmission map is performed based on a plurality of different thresholds, and a plurality of foreground maps each representing the foreground area within a captured image is generated. Examples of the thresholds include a median. Further, a transmittance histogram may be generated and its local minimum point may be set as a threshold. The foreground area within the captured image is a two-dimensional area in which opaque voxels are present in the three-dimensional shape to be estimated, as viewed from the viewpoint of the image capturing apparatus 101. The background area is a two-dimensional area in which only transparent voxels are present. The foreground map is as an image representing an opaque area (foreground area) and a transparent area (background area) in binary. By setting a threshold, a translucent area of the subject in the captured image is set as the foreground area or the background area. A plurality of three-dimensional shapes is estimated using the foreground map for each threshold. In the obtained three-dimensional shapes, the translucent area of the subject is represented by opaque or transparent voxels depending on the threshold. Transmission information about the subject can be obtained with reference to the difference between the three-dimensional shapes. In the first exemplary embodiment, processing to be performed when two thresholds are set will be described. A three-dimensional shape in which all translucent areas of the subject are set as the foreground area based on one threshold and the entire subject, including the translucent areas and opaque areas, is represented by opaque voxels is estimated. This three-dimensional shape is hereinafter referred to as a translucent foreground three-dimensional shape. In other words, the translucent foreground three-dimensional shape is a three-dimensional shape including both the translucent area and the opaque area. A three-dimensional shape representing only opaque areas is estimated in such a manner that all translucent areas of the subject are set as the background area based on another threshold and voxels are identified from the opaque areas of the subject. This three-dimensional shape is hereinafter referred to as an opaque foreground three-dimensional shape. In the first exemplary embodiment, the translucent foreground three-dimensional shape and the opaque foreground three-dimensional shape are collectively referred to as a three-dimensional shape including transmission information. At least one threshold may be used, and two or more types of three-dimensional shapes may be generated. In the first exemplary embodiment, each three-dimensional shape is represented by transparent or opaque voxels. Alternatively, for example, a value indicating whether the subject is present may be stored in all voxels, and the three-dimensional shape may be obtained with reference to the value.

Since the translucent foreground three-dimensional shape includes both the translucent area and the opaque area, additional information indicating which one of the translucent area and the opaque area includes each of the components of the translucent foreground three-dimensional shape may be added to the corresponding components. This additional information may be indicated in binary. For example, “0” may be set to indicate that the component is included in the translucent area and “1” may be set to indicate that the component is included in the opaque area. These values may be reversed, or may represent “true” and “false”.

The virtual viewpoint obtaining unit 104 obtains viewpoint information about a virtual viewpoint used for rendering a virtual viewpoint image. The viewpoint information about the virtual viewpoint includes at least a position of a virtual viewpoint, a line-of-sight direction from the virtual viewpoint, and an angle of view. The viewpoint information about the virtual viewpoint is associated with a frame number or time code added to the captured image. The viewpoint information about the virtual viewpoint is identified by an operator operating an input device such as a mouse or a keyboard. Viewpoint information about temporally continuous virtual viewpoints, which has been preliminarily generated, may be obtained from a storage device (not illustrated).

The texture selection unit 105 selects a texture to be used to generate a view from the virtual viewpoint in the virtual viewpoint image generation unit 106 from among the captured images by using the captured images, the three-dimensional shape including transmission information, and the viewpoint information about the virtual viewpoint. In the first exemplary embodiment, the captured image to be used for the texture for two three-dimensional shapes obtained from the three-dimensional shape estimation unit 103 is selected. This processing is hereinafter referred to as texture selection processing.

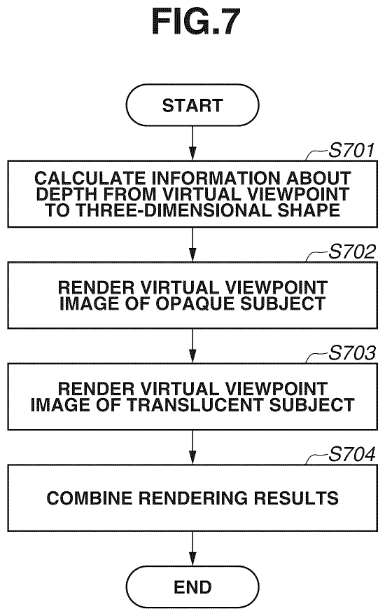

The virtual viewpoint image generation unit 106 obtains the three-dimensional shapes, which is to be obtained from the three-dimensional shape estimation unit 103, the transmittance map, which is to be obtained from the transmittance map generation unit 102, the captured image, which is to be obtained from the texture selection unit 105, and the viewpoint information about the virtual viewpoint, which is to be obtained from the virtual viewpoint obtaining unit 104. The virtual viewpoint image generation unit 106 uses the obtained information to generate a virtual viewpoint image including the translucent area of the subject and a virtual viewpoint image including the opaque area of the subject. Further, the virtual viewpoint image generation unit 106 combines the generated virtual viewpoint images, thereby generating a virtual viewpoint image including an opaque subject. For example, Z-sorting may be used as a method for rendering the virtual viewpoint image. This method is described in detail below with reference to a flowchart illustrated in FIG. 7.

The output apparatus 107 outputs the virtual viewpoint image generated by the virtual viewpoint image generation unit 106, and displays the virtual viewpoint image on a display device such as a display. The virtual viewpoint image may be transmitted to a storage device such as a server.

The image processing apparatus 108 is a personal computer (PC) or a tablet terminal, and may include a display unit (not illustrated).

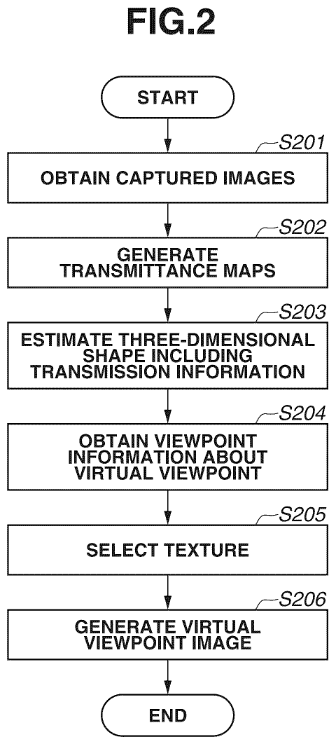

FIG. 2 is a flowchart illustrating virtual viewpoint image generation processing to be performed by the image processing system according to the first exemplary embodiment.

In step S201, the plurality of image capturing apparatuses 101 obtains captured images of a subject. The obtained captured images are output to the transmittance map generation unit 102 and the texture selection unit 105.

In step S202, the transmittance map generation unit 102 generates a plurality of transmittance maps each corresponding to a corresponding captured image of the plurality of captured images using a trained model. Each transmittance map represents transmission information about the subject in the corresponding captured image. The transmission map will be described in detail below in conjunction with the transmittance map generation unit 102, which will be described below.

The plurality of generated transmittance maps is output to the three-dimensional shape estimation unit 103 and the virtual viewpoint image generation unit 106.

In step S203, the three-dimensional shape estimation unit 103 estimates a three-dimensional shape including transmission information. The three-dimensional shape including transmission information is used by the texture selection unit 105 and the virtual viewpoint image generation unit 106.

In step S204, the virtual viewpoint obtaining unit 104 obtains viewpoint information about a virtual viewpoint. The viewpoint information about the virtual viewpoint is used for the texture selection unit 105 and the virtual viewpoint image generation unit 106.

In step S205, the texture selection unit 105 selects a texture (captured image) to be used for processing of determining color information about each component of the three-dimensional shape. The selected texture is used for the virtual viewpoint image generation unit 106.

In step S206, the virtual viewpoint image generation unit 106 generates a virtual viewpoint image. The generated virtual viewpoint image is output to the output apparatus 107.

FIGS. 3A to 3C illustrate an outline of a scene to be reproduced according to the first exemplary embodiment. FIG. 3A illustrates a scene in which images of a subject 301a and a subject 301b are captured by the image capturing apparatuses 101. The subject 301a partially includes a translucent portion. Specifically, a dark gray portion corresponds to the opaque portion and a light gray portion corresponds to the translucent portion. The subject 301b is an opaque subject.

Cameras 302a to 302c function as the image capturing apparatuses 101 to capture images of the subject 301a and the subject 301b. A virtual viewpoint 303 is located at a position illustrated in FIG. 3A, and a view from the virtual viewpoint 303 is generated as the virtual viewpoint image. FIG. 3B illustrates an image captured by the camera 302b. FIG. 3C illustrates a transmittance map generated for the captured image illustrated in FIG. 3B. In the first exemplary embodiment, higher transmittance is displayed as darker, and lower transmittance is displayed as lighter.

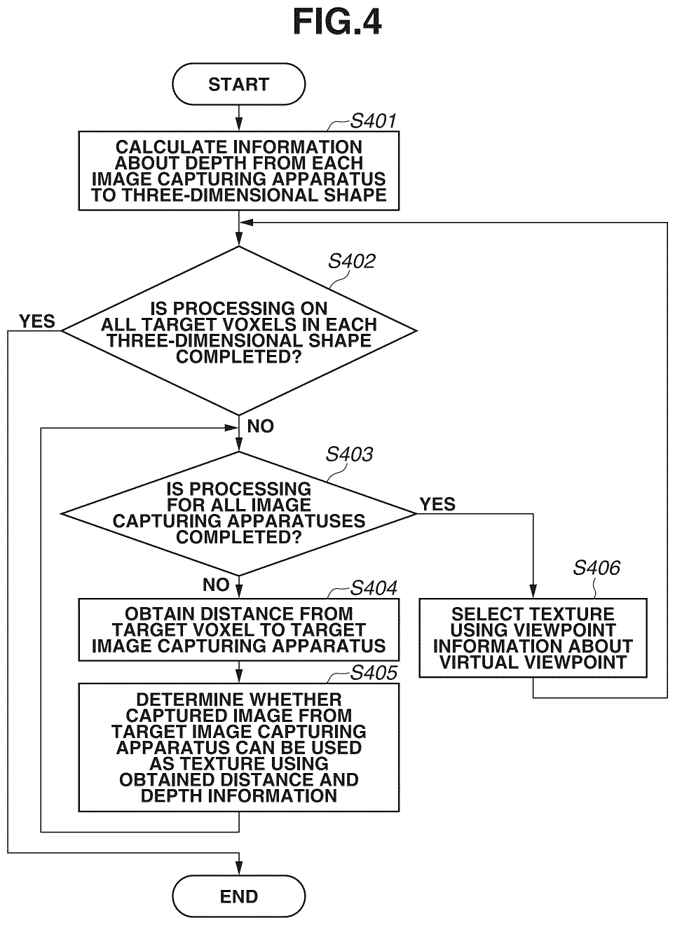

FIG. 4 is a flowchart illustrating texture selection processing to be performed by the texture selection unit 105 according to the first exemplary embodiment.

In step S401, depth information for the depth of a three-dimensional shape is calculated from the corresponding image capturing apparatus 101. The depth information indicates, for example, a distance from each image capturing apparatus 101 to the surface of the corresponding three-dimensional shape. In the first exemplary embodiment, two types of three-dimensional shapes, namely, the translucent foreground three-dimensional shape and the opaque foreground three-dimensional shape are used, and the depth information is calculated for each type. The depth information for each captured image can be calculated and stored in advance.

In step S402, it is determined whether operations in steps S403 to S406 to be described below is completed for all the target voxels. All voxels may be set as the target voxels, or only the surface voxels may be set as the target voxels. Voxels visible from the virtual viewpoint may be set as the target voxels. If the selecting of the captured image to be used as the texture for all the target voxels is completed (YES in step S402), the processing of the texture selection unit 105 ends. If the processing is not completed (NO in step S402), the operations in steps S403 to S406 are performed on the remaining voxels.

In step S403, it is determined whether the operations in steps S404 and S405 to be described below are completed, respectively, for the target voxels from which the captured image used as the texture is selected and for all the image capturing apparatuses 101. If it is determined that the operations are completed (YES in step S403), the processing proceeds to step S406. If the processing is not completed (NO in step S403), the operations in steps S404 and S405 are performed on the remaining image capturing apparatuses 101.

In step S404, back projection processing is performed on the target image capturing apparatus 101 from the target voxel to thereby obtain the distance from the target voxel to the target image capturing apparatus 101.

In step S405, it is determined whether the captured image from the target image capturing apparatus 101 can be used as the texture to generate the virtual viewpoint image for the target voxel using the depth information obtained in step S401 and the distance obtained in step S404. The determination method varies depending on the transmission information included in the three-dimensional shape. The determination method will be described in detail below. As the determination result, a value indicating whether the captured image from the target image capturing apparatus 101 can be used as the texture for the target voxel may be used. For example, flag information indicating “true” when the captured image can be used as the texture and indicating “false” when the captured image cannot be used as the texture may be used. The determination result may be stored as a voxel value, or may be stored in a table in such a manner that the determination result is in association with the corresponding voxel.

In step S406, the captured image to be used as the texture to be used in generation of the virtual viewpoint image is selected based on the viewpoint information about the virtual viewpoint obtained by the virtual viewpoint obtaining unit 104 for the target voxel.

As a selection method, for example, a captured image(s) from one or more image capturing apparatuses 101 that are closest to the virtual viewpoint in the position or line-of-sight direction thereof is selected, as one(s) to be used for texture, from among the captured images determined to be usable in step S405. In addition to the captured image(s), the transmittance map for the corresponding captured image(s) may be selected as the transmittance of the texture at once. During the selection, the distance from each image capturing apparatus 101 to the virtual viewpoint, or an angular difference may be normalized and the normalized value may be added as a coefficient to the texture or the captured image. Further, in step S406, the selection processing may be performed after it is determined whether the target voxel can be directly viewed from the virtual viewpoint. The selection processing of selecting a captured image to be used for a texture may be performed on the voxels that can be viewed from the virtual viewpoint, and the texture selection processing on voxels that are located outside of the angle of view, voxels other than the surface voxels, or voxels shielded by other voxels may be omitted. Through the operations in steps S401 to S406 described above, the selection of the captured image to be used as the texture used for generation of the virtual viewpoint of the three-dimensional shape is completed and the selected captured image is output as the texture to the virtual viewpoint image generation unit 106. The captured image to be used as the texture selected in step S406 may be stored in association with each voxel of the three-dimensional shape. In other words, a captured image available per voxel may be assigned a unique number or a unique captured image name representing the corresponding image capturing apparatus 101.

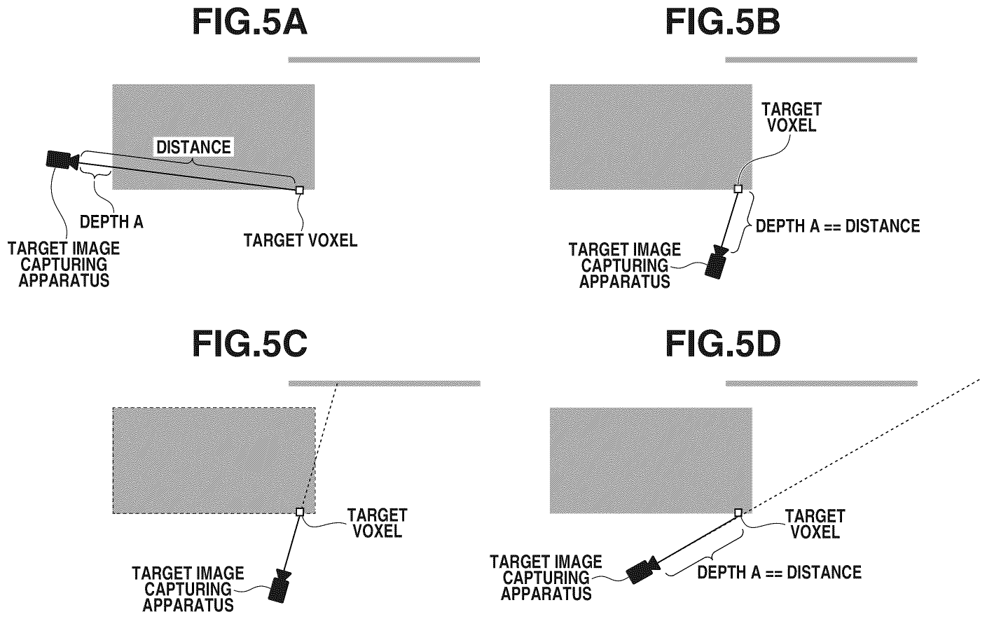

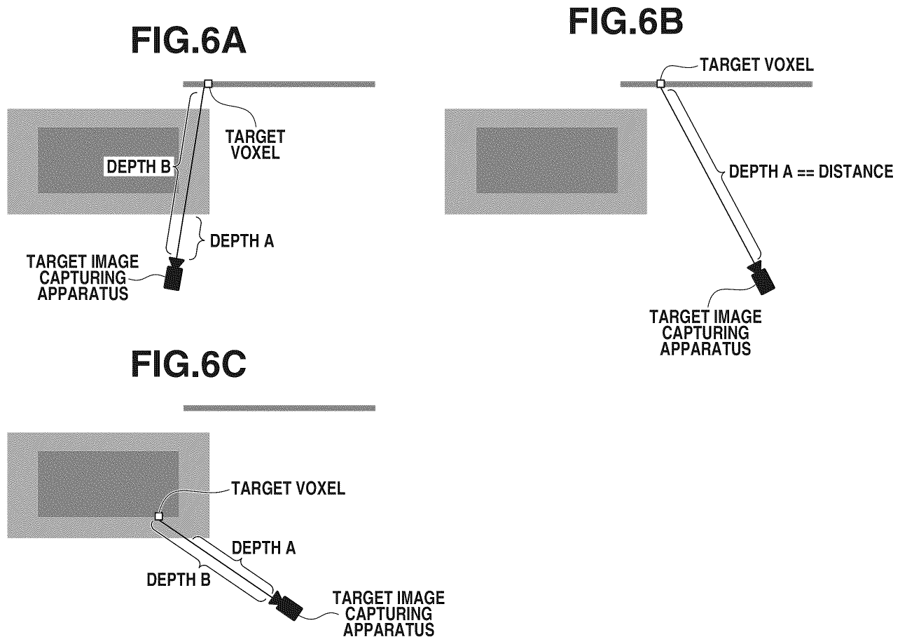

The determination of the captured image that can be used as the texture in step S405 will be described in detail with reference to FIGS. 5A to 5D and FIGS. 6A to 6C. The determination method varies depending on the type of the three-dimensional shape. According to the first exemplary embodiment, in the depth information calculated in the step S401, depth information indicating a depth to the surface of the translucent foreground three-dimensional shape estimated by the three-dimensional shape estimation unit 103 is referred to as a depth A, and depth information indicating a depth to the surface of the opaque foreground three-dimensional shape is referred to as a depth B.

FIGS. 5A to 5D each illustrate processing for determining the captured image that can be used as the texture for the translucent foreground three-dimensional shape. In other words, this processing is processing of selecting the captured image to be used to determine color information for each component of the translucent foreground three-dimensional shape. A method of determining the translucent foreground three-dimensional shape will now be described with reference to FIGS. 5A to 5D. FIGS. 5A to 5D are overhead-view diagrams each illustrating a surface voxel of the translucent foreground three-dimensional shape for the scene illustrated in FIG. 3A. Specifically, two determinations are made for the translucent foreground three-dimensional shape. If both are satisfied, it is determined that the captured image from the target image capturing apparatus 101 can be used as the texture. In the first determination, it is determined whether the target voxel can be directly viewed from the target image capturing apparatus 101. For the captured image of the target image capturing apparatus 101 to be determined usable as a texture, visibility is required. If the depth A obtained in step S401 matches the distance from the target voxel to the target image capturing apparatus 101 obtained in step S404, or if the difference between the depth A and the distance is less than a predetermined threshold, it is determined that the target voxel is visible. As the predetermined threshold, for example, a certain value or a value determined depending on a target subject can be used. The predetermined threshold can be determined by taking into consideration the thickness of general translucent clothes and the range of the clothes. FIG. 5A illustrates an example where the difference between the depth A and the distance from the target voxel to the target image capturing apparatus 101 is more than or equal to the predetermined threshold and thus it can be determined that the target voxel is not visible. FIG. 5B illustrates an example where the depth A matches the distance and thus it can be determined that the target voxel is visible. In the second determination, it is determined whether another object is present on an extension (straight line) of a straight line leading from the target image capturing apparatus 101 to the target voxel. For the captured image of the target capturing apparatus 101 to be determined usable as a texture, the absence of any other objects on the extension is required. FIG. 5C illustrates an example where another subject is present on the extension and thus it is determined that the captured image from the target image capturing apparatus 101 cannot be used as the texture. FIG. 5D illustrates an example where no other objects are present on the extension. In the example illustrated in FIG. 5D, it is also determined that the target voxel is visible, and thus it is determined that the captured image from the target image capturing apparatus 101 can be used as the texture. As a method of determining whether another object is present on the extension, for example, the number of surface voxels in the extension direction are counted, and if the counted number is two, or is more than or equal to a predetermined number, it is determined that a plurality of subjects is penetrated and thus it is determined that another object is present on the extension. The two determinations make it possible to select the captured image in which the target voxel can be directly viewed and no other subjects are present behind the subject in the translucent area and thus there is no texture color mixing, and to determine the captured image as the texture.

FIGS. 6A to 6C each illustrate processing for determining the captured image that can be used as the texture for the opaque foreground three-dimensional shape. FIGS. 6A to 6C are overhead-view diagrams each illustrating the opaque foreground three-dimensional shape (rectangular area with a dark color) and the translucent foreground three-dimensional shape (rectangular area with a light color) that are overlaid for the scene illustrated in FIG. 3A. Two determinations are also made on the opaque foreground three-dimensional shape in a manner similar to that described above. If both are satisfied, it is determined that the captured image from the target image capturing apparatus 101 can be used as the texture. In the first determination, the visibility is determined as in the determination for the translucent foreground three-dimensional shape. A determination method similar to that described above may be used. In the second determination, it is determined whether the depth A matches the depth B in a straight line direction from the target image capturing apparatus 101 to the target voxel, or whether the difference between the depth A and the depth B is less than a predetermined threshold. For the captured image of the target capturing apparatus 101 to be determined usable as a texture, it is necessary that the depth A matches the depth B or the difference between the depth A and the depth B is less than the predetermined threshold. For example, in the example illustrated in FIG. 6A, the difference between the depth A and the depth B is more than or equal to the predetermined threshold, and thus it is determined that the captured image from the target image capturing apparatus 101 cannot be used as the texture. In the example illustrated in FIG. 6B, the depth A matches the depth B and the target voxel is visible, and thus it is determined that the captured image can be used as the texture. In the example illustrated in FIG. 6C, the difference between the depth A and the depth B is less than the predetermined threshold and the target voxel is visible since the depth B matches the distance from the target voxel to the target image capturing apparatus 101, and thus it is determined that the captured image can be used as the texture. The two determinations described above make it possible to select the captured images in which the target voxel can be directly viewed and no other subjects are present in front of the target voxel, or on which only a thin translucent subject is overlapped, which prevents texture color missing. These captured images are determined to be useable as the texture. As a form of the selected texture, the determination results in steps S405 and S406 for the target voxel per pixel of all captured images, including the captured images determined to be unusable in steps S405 and S406, may be simultaneously provided and output. The determination results may be, for example, flag information indicating “true” when the captured image can be used and indicating “false” when the captured image cannot be used. Further, the results of the two determinations performed in step S405 may be provided.

FIG. 7 is a flowchart illustrating virtual viewpoint image generation processing to be performed by the virtual viewpoint image generation unit 106 according to the first exemplary embodiment.

In step S701, depth information indicating a depth (distance) from the virtual viewpoint to the three-dimensional shape including transmission information is calculated based on viewpoint information about the virtual viewpoint obtained from the virtual viewpoint obtaining unit 104. In the first exemplary embodiment, the depth information for each of the translucent foreground three-dimensional shape and the opaque foreground three-dimensional shape is calculated.

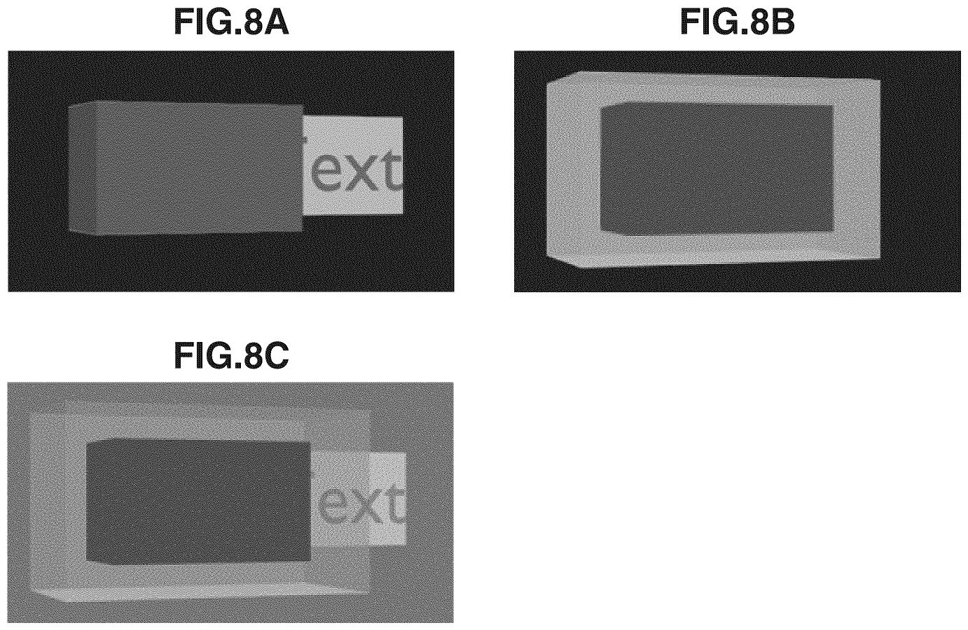

In step S702, a virtual viewpoint image of an opaque subject is rendered based on selected texture information using the captured images, the transmittance maps, the opaque foreground three-dimensional shape, and the depth information indicating the depth from the virtual viewpoint. As a rendering method, for example, voxels constituting the surface of the three-dimensional shape when the three-dimensional shape is viewed from the virtual viewpoint are identified using the depth information. The texture selected through the processing illustrated in FIG. 4 is used as a pixel color for a target voxel to be rendered among the identified voxels constituting the surface. If there is a plurality of textures selected as surface voxels, the textures may be blended and the blended color may be used as a rendering color. As a coefficient for blending, for example, a value obtained by normalizing the distance from the target image capturing apparatus 101 to the virtual viewpoint, or the angular difference may be used. Further, as discussed in Japanese Patent Application Laid-Open No. H06-225329, the background color may be removed from the selected texture using the transmittance map. During rendering, not only the color information, but also the transmittance of the selected texture may be used as the transmittance of the target voxel. FIG. 8A illustrates a rendering result in step S702 for the scene illustrated in FIG. 3A. This processing is executed on all voxels that are determined to constitute the surface of the subject.

In step S703, a virtual viewpoint image of a translucent subject is rendered based on the selected texture information using the captured images, the transmittance maps, the translucent foreground three-dimensional shape, and the depth information indicating the depth from the virtual viewpoint. To render only the translucent area from the translucent foreground three-dimensional shape, the translucent foreground three-dimensional shape is compared with the opaque foreground three-dimensional shape, and opaque voxels that are present only in the translucent foreground three-dimensional shape are rendered as target voxels. A rendering method similar to that used in step S702 may be used. FIG. 8B illustrates a rendering result in step S702 for the scene illustrated in FIG. 3A.

In step S704, the area in which only the translucent subject is present is overwritten with the rendering result obtained in step S703 and is combined with the rendering result for the opaque subject obtained in step S702. The combining processing is performed based on the transmittance of the rendering result obtained in step S703. FIG. 8C illustrates a combining processing result obtained in step S704 for the scene illustrated in FIG. 3A. In the case of rendering a translucent subject in step S703, a texture of a partially opaque subject may be used depending on the threshold set by the texture selection unit 105 in step S405. For example, if a thin translucent object is present on the surface of the opaque subject as illustrated in FIG. 6C and a threshold is set high in step S405, the texture including the opaque subject is selected. However, the rendering result of the opaque subject is overwritten during combining processing in step S704, so that a natural virtual viewpoint can ultimately be obtained. Before the rendering result of the opaque subject is combined with the rendering result of the translucent subject, color information about the background image may be removed from the area of the translucent subject in the rendering result of the translucent subject, that is, in the virtual viewpoint image including the translucent subject.

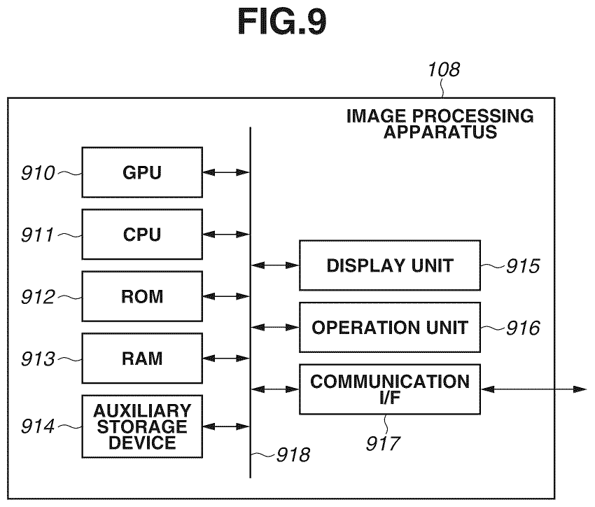

FIG. 9 is a block diagram illustrating a hardware configuration of the image processing apparatus 108. The image processing apparatus 108 includes an arithmetic unit including a graphics processing unit (GPU) 910 and a central processing unit (CPU) 911. The arithmetic unit is a unit for generating a three-dimensional shape and performing image processing. The image processing apparatus 108 further includes a storage unit including a read-only memory (ROM) 912, a random access memory (RAM) 913, and an auxiliary storage device 914. The image processing apparatus 108 further includes a display unit 915, an operation unit 916, a communication interface (I/F) 917, and a bus 918.

The CPU 911 controls an overall operation of the image processing apparatus 108 using computer programs and data stored in the ROM 912 or the RAM 913, thereby implementing the functions of the image processing apparatus 108. The CPU 911 also operates as a display control unit for controlling the display unit 915 and as an operation control unit for controlling the operation unit 916.

The GPU 910 can perform efficient arithmetic operations by performing parallel processing of larger amounts of data. Accordingly, in the first exemplary embodiment, not only the CPU 911, but also the GPU 910 is used for the transmittance map generation unit 102, the three-dimensional shape estimation unit 103, the texture selection unit 105, and the virtual viewpoint image generation unit 106. In the case of executing a program, only one of the CPU 911 and the GPU 910 may perform an arithmetic operation, or both the CPU 911 and the GPU 910 may perform an arithmetic operation in cooperation.

The image processing apparatus 108 may include one or more pieces of dedicated hardware different from the CPU 911, and the dedicated hardware may execute at least a part of the processing to be performed by the CPU 911. Examples of the dedicated hardware include an application-specific integrated circuit (ASIC), a field-programmable gate array (FPGA), and a digital signal processor (DSP).

The ROM 912 stores programs and the like that are not required to be changed. The RAM 913 temporarily stores programs and data supplied from the auxiliary storage device 914, and data and the like supplied from an external apparatus via the communication I/F 917. The auxiliary storage device 914 is composed of, for example, a hard disk drive, and stores various data such as image data and audio data.

The display unit 915 is composed of, for example, a liquid crystal display or a light-emitting diode (LED), and displays a graphical user interface (GUI) or the like for the user to operate an information processing apparatus. The operation unit 916 is composed of, for example, a keyboard, a mouse, a joystick, or a touch panel. The operation unit 916 receives a user operation and inputs various instructions to the CPU 911.

The communication I/F 917 is used for communication between the information processing apparatus and the external apparatus. For example, if the information processing apparatus is connected to the external apparatus with a wire, a communication cable is connected to the communication I/F 917. If the information processing apparatus includes a function for establishing wireless communication with the external apparatus, the communication I/F 917 includes an antenna. The bus 918 connects the units of the information processing apparatus to each other to transmit information.

In the first exemplary embodiment, transmittance maps are generated, for a translucent subject, a three-dimensional shape including transmission information is estimated, a texture to be used to generate a virtual viewpoint image is selected from among captured images, and a virtual viewpoint image is generated. According to the first exemplary embodiment, it is possible to use an appropriate texture and obtain a natural virtual viewpoint.

According to the present disclosure, it is possible to generate a virtual viewpoint image that includes a subject with a high transmittance and is represented by appropriate colors.

Further, in the first exemplary embodiment, a foreground area and a background area are set for a transparent area and a three-dimensional shape including transmission information is generated by providing a three-dimensional shape with a plurality of binary values. Alternatively, a three-dimensional shape with a single multiple value may be generated. In this case, the texture selection unit 105 and the virtual viewpoint image generation unit 106 may perform each processing after a threshold for defining a foreground area or a background area is set to each voxel value and binarization processing is performed.

In the texture selection unit 105 according to the first exemplary embodiment, a captured image including an area where a translucent subject overlaps another subject is not used for rendering so that an appropriate captured image can be used as the texture. However, a more natural virtual viewpoint image can be obtained if the captured image as described above can be used depending on the position and orientation of the virtual viewpoint and each image capturing apparatus 101 and the positional relationship between each image capturing apparatus 101 and the subject. For example, in a case where it is determined that the image capturing apparatus 101 located near the virtual viewpoint cannot be used and the image capturing apparatus 101 located at a position apart from the virtual viewpoint is used, the resolution of the texture decreases, which causes a sense of incongruity. Additionally, there is a possibility that the appearance of an anisotropic subject from the virtual viewpoint cannot be accurately reproduced. Thus, in a second exemplary embodiment, for a captured image where the above-described translucent subject overlaps with other subjects, the captured image of the translucent subject in the overlapping area is corrected and made available as a texture to generate the virtual viewpoint image.

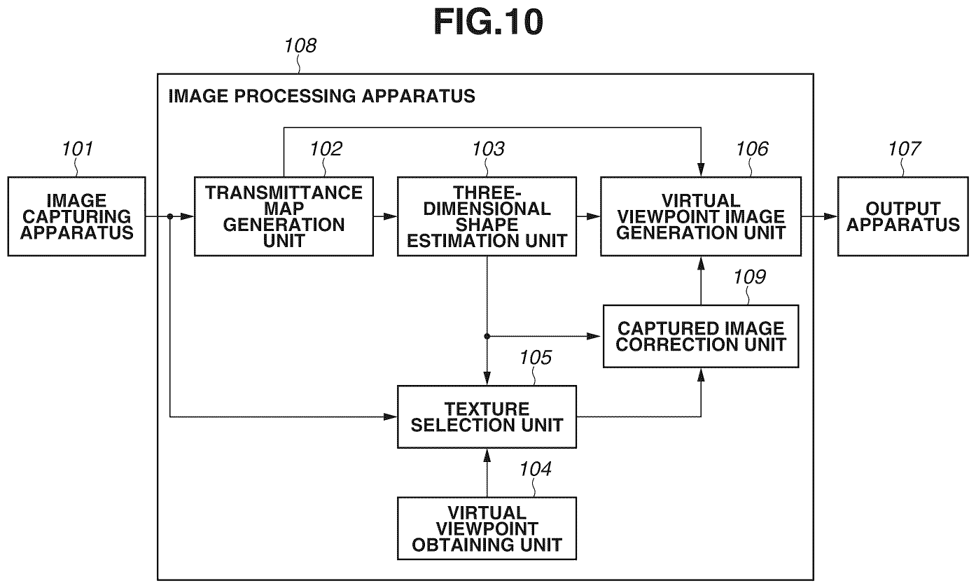

FIG. 10 is a block diagram illustrating an overall configuration of an image processing system. The difference between the second exemplary embodiment and the first exemplary embodiment will be mainly described below, and descriptions of components in the second exemplary embodiment that are identical to the components in the first exemplary embodiment are omitted. The second exemplary embodiment differs from the first exemplary embodiment in that a captured image correction unit 109 is added. This apparatus may be composed of a single electronic device, or may be composed of a plurality of electronic devices.

The captured image correction unit 109 sorts out a camera used to correct the texture based on selected captured image information, and corrects the captured image which has been determined to be unusable as the texture, using information about the position of each image capturing apparatus 101 and the angle of view. The corrected image can be used as the texture.

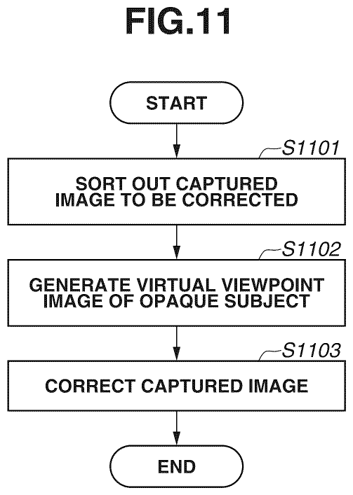

FIG. 11 is a flowchart illustrating captured image correction processing to be performed by the captured image correction unit 109.

In step S1101, a captured image to be corrected is sorted out. The captured image that is to be corrected and is to be used as the texture is sorted out using the viewpoint information about the virtual viewpoint and the determination results obtained in steps S405 and S406 for each pixel in the captured image by the texture selection unit 105. Specifically, the determination results include the determination result indicating whether the captured image can be used based on the visibility and the determination result indicating whether the captured image can be used based on the positional relationship between the virtual viewpoint position and the position of each image capturing apparatus 101. For example, the captured image from the image capturing apparatus 101 for which it is determined that the target voxel is visible in step S405, but another object is present on the extension of the target voxel from the target image capturing apparatus 101 is sorted out as a correction target. Additionally, the captured image that is not selected as the texture is sorted out as the correction target based on the determination result in step S406. Further, the image capturing apparatus 101 that is closest to the position or orientation of the virtual viewpoint may be sorted out based on the viewpoint information about the virtual viewpoint.

In step S1102, a virtual viewpoint image of an opaque subject from the virtual viewpoint at the position of the target image capturing apparatus 101 is generated with the image capturing apparatus 101 that has obtained the captured image to be corrected set to another virtual viewpoint, as in the operation in step S702 performed by the virtual viewpoint image generation unit 106. As a result, a view from the target image capturing apparatus 101 when the translucent subject is not present can be generated.

In step S1103, the captured image is corrected such that the color of the other subjects in the overlapping area is removed from the texture of the translucent subject using the captured image to be corrected and the virtual viewpoint image obtained in step S1102. As a correction method, for example, as discussed in Japanese Patent Application Laid-Open No. H06-225329, the captured image is set as a foreground image, the virtual viewpoint image is set as a background image, and the transmittance map for the foreground image is calculated. The color of the virtual viewpoint image as the background image is removed from the captured image using the transmittance map. The captured image corrected by the captured image correction unit 109 is changed to the captured image that can be used as the texture, and thus can be used for the virtual viewpoint image generation unit 106.

As described above, the texture of the area where other subjects overlap the translucent area of the captured image can be corrected. Thus, the amount of the texture to be used can be increased and coloring processing can be performed by blending colors of a plurality of captured images, so that a more natural virtual viewpoint can be obtained.

The present disclosure can also be implemented by processing in which a program for implementing one or more functions according to the exemplary embodiments described above is supplied to a system or an apparatus via a network or a storage medium, and one or more processors in a computer of the system or the apparatus read out and execute the program. The present disclosure can also be implemented by a circuit (e.g., an ASIC) for implementing one or more functions according to the exemplary embodiments described above.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-088440, filed May 30, 2024, which is hereby incorporated by reference herein in its entirety.

What is claimed is:

1. An image processing system comprising:
one or more memories configured to store instructions; and
one or more processors configured to, upon executing the instructions:
obtain viewpoint information indicating a position of a virtual viewpoint and a line-of-sight direction from the virtual viewpoint;
generate a first virtual viewpoint image including a transparent or translucent first portion of a subject using the viewpoint information and a first captured image including the first portion and a pixel not corresponding to an opaque second portion of the subject to be captured through the first portion among a plurality of pixels corresponding to the first portion, and generate a second virtual viewpoint image including the second portion using the viewpoint information and a second captured image including the second portion; and
generate a third virtual viewpoint image including the first portion and the second portion based on the first virtual viewpoint image and the second virtual viewpoint image.

2. The image processing system according to claim 1,
wherein the pixel not corresponding to the second portion to be captured through the first portion in the first captured image corresponds to a specific pixel of the first portion in the first virtual viewpoint image, and
wherein color information about the specific pixel is determined using information about the color of the pixel not corresponding to the second portion to be captured through the first portion.

3. The image processing system according to claim 2, wherein the pixel not corresponding to the second portion to be captured through the first portion in the first captured image and the specific pixel of the first portion in the first virtual viewpoint image correspond to a specific component of a three-dimensional shape of the subject.

4. The image processing system according to claim 1, wherein the second captured image is a captured image including the second portion to be captured through the first portion.

5. The image processing system according to claim 1, wherein the first captured image and the second captured image are the same captured image.

6. The image processing system according to claim 1, wherein color information about the second portion in the second virtual viewpoint image is determined using color information excluding color information corresponding to the first portion from color information about a pixel corresponding to the second portion to be captured through the first portion in the first captured image.

7. The image processing system according to claim 1, wherein the one or more processors execute the instructions further to:
obtain a plurality of captured images including the subject;
obtain a plurality of pieces of transmittance information each corresponding to a corresponding captured image of the plurality of captured images, using a trained model configured to output the plurality of pieces of transmittance information indicating a transmittance of an area corresponding to the subject in the plurality of captured images using the plurality of captured images as an input; and
identify the first captured image and the second captured image, among the plurality of captured images, based on the plurality of pieces of transmittance information.

8. The image processing system according to claim 7, wherein the one or more processors execute the instructions further to generate shape information indicating a three-dimensional shape of the subject including a transparent or translucent first component and an opaque second component based on the plurality of captured images, positional information about a plurality of image capturing apparatuses that has captured the plurality of captured images, and the plurality of pieces of transmittance information;
identify, as the first captured image, a captured image in which the first portion is included in an image capturing range of an image capturing apparatus and the second component is not present on a straight line passing through the first component from a position in a virtual space corresponding to a position in a real space of the image capturing apparatus, among the plurality of captured images; and
identify, as a captured image including the second portion, a captured image including the second portion in the image capturing range of the image capturing apparatus.

9. The image processing system according to claim 8, wherein the one or more processors execute the instructions further to:
identify, as a transparent or translucent area, an area with a transmittance in the area corresponding to the subject being more than or equal to a threshold in each of the plurality of captured images, and identify, as an opaque area, an area with a transmittance in the area corresponding to the subject being less than the threshold; and
generate the shape information by generating the first component using the transparent or translucent area in the plurality of captured images and generating the second component using the opaque area in the plurality of captured images.

10. The image processing system according to claim 1, wherein the third virtual viewpoint image is generated by removing a background color from an area corresponding to the first portion in the first virtual viewpoint image and combining the first virtual viewpoint image with the second virtual viewpoint image.

11. An image processing method comprising:
obtaining viewpoint information indicating a position of a virtual viewpoint and a line-of-sight direction from the virtual viewpoint;
generating a first virtual viewpoint image including a transparent or translucent first portion of a subject using the viewpoint information and a first captured image including the first portion and a pixel not corresponding to an opaque second portion of the subject to be captured through the first portion among a plurality of pixels corresponding to the first portion, and generating a second virtual viewpoint image including the second portion using the viewpoint information and a second captured image including the second portion; and
generating a third virtual viewpoint image including the first portion and the second portion based on the first virtual viewpoint image and the second virtual viewpoint image.

12. A non-transitory computer-readable storage medium storing a program for causing a computer that has a display unit to execute a control method of an image processing system comprising:
obtaining viewpoint information indicating a position of a virtual viewpoint and a line-of-sight direction from the virtual viewpoint;
generating a first virtual viewpoint image including a transparent or translucent first portion of a subject using the viewpoint information and a first captured image including the first portion and a pixel not corresponding to an opaque second portion of the subject to be captured through the first portion among a plurality of pixels corresponding to the first portion, and generating a second virtual viewpoint image including the second portion using the viewpoint information and a second captured image including the second portion; and
generating a third virtual viewpoint image including the first portion and the second portion based on the first virtual viewpoint image and the second virtual viewpoint image.
